(19) United States
(12) Patent Application Publication
(10) Pub. No.: US 2018/0075384 A1
(43) Pub. Date: Mar. 15, 2018

(54) A Data-driven Innovation Decision Support System, and Method

(71) Applicant: Singapore University of Technology and Design, Singapore (SG)

(72) Inventor: Jianxi Luo, Singapore (SG)

(21) Appl. No.: 15/559,079

(22) PCT Filed: Mar. 18, 2016
(86) PCT No.: PCT/SG2016/050127

§ 371 Date: Sep. 18, 2017

(30) Foreign Application Priority Data
Mar. 18, 2015 (SG) 10201502100Q

(51) Int. Cl. G06Q 10/06; G06Q 50/18; G06N 5/04

(52) U.S. Cl. CPC G06Q 10/0637; G06N 5/048; G06N 5/045; G06Q 50/184

(57) ABSTRACT

There is provided a data processor implemented method for assessing an innovation entity within a network map of various technology domains as nodes. The method comprises generating and visualizing the network map; assessing and visualizing a level of strength of the innovation entity in each technology domain; and providing at least one suggestion for the innovation entity for at least two nodes of the network map. It is advantageous that the provision of the at least one suggestion is based on a weight of a link between the at least two nodes of the network map. A graphical user interface enabling the method is also provided.

### FIELD OF INVENTION

Embodiments of the present invention relate to a data-driven decision support system, and method.

### BACKGROUND

Currently, the knowledge-based economy that is prevalent in many developed countries requires continuous innovation, whether by, for example, individuals, corporate entities, government agencies, states, countries, multi-country regions and so forth. It is typical that decisions about, for example, what, where, how, to innovate will need to be made regularly. In addition, decisions need to be made about what technologies to focus on or to discard, which technology domains to enter, long-term directions for innovation and so forth. Presently, such decisions are often made based on gut feel/intuition/experience of decision makers.

However, before making any of the aforementioned decisions, the decision makers typically engage “technology road-mapping” services provided by consulting firms. Such “roadmaps” are usually formed using, for example, qualitative analysis, scattered evidence, expert opinions, and are typically presented as qualitative diagrams.

In addition, there have been several academic publications which disclose various means to create network maps of patent technology classes. However, these papers primarily focus on network visualization techniques (qualitative diagrams), and does not have features and functions that provide indicators to guide the decision maker towards a direction for innovation.

### SUMMARY

There is provided a data processor implemented method for assessing an innovation entity within a network map of technology domains as nodes. The method comprises generating and visualizing the network map; assessing and visualizing a level of strength of the innovation entity in each technology domain; and providing at least one suggestion for the innovation entity for at least two nodes of the network map. It is advantageous that the provision of the at least one suggestion is based on a weight of a link between the at least two nodes of the network map.

It is preferable that the at least one suggestion is at least one of: to enhance capabilities in respective new technology domains; and to leverage on existing technology from at least one current technology domain.

The network map can preferably comprise a plurality of nodes and a plurality of links.

The innovation entity can preferably be selected from, for example, an individual, a corporate entity, a government agency, a state, a country a multi-country region, and so forth.

Preferably, the weight of a link is based on citations or classification information of technical documents established over a predetermined period of time in technology domains represented by respective nodes. The weight of a link can preferably be determined using at least one measure such as, for example, ratio of a number of the citations in common in the technology domains represented by the pair of nodes to a number of the total number of unique citations in the technology domains represented by the pair of nodes, cosine of an angle of two vectors representing how the citations in the technology domains represented by the pair of nodes are distributed across different technology domains, and cosine of an angle of two vectors representing how the citations in the technology domains represented by the pair of nodes are distributed across different technical documents.

Alternatively, the weight of a link is based on minimum pairwise conditional probabilities of the innovation entity having strong technology capability in a first technology domain, given that the innovation entity also has strong technology capability in a second technology domain.

In yet another alternative, the weight of a link is based on a ratio of shared technical documents to a number of unique technical documents in the technology domains represented by the pair of nodes.

Preferably, the network map further comprises information for each node relating to the technology domain represented by the node. It is preferable that each node has a size indicative of a number of documents established over a predetermined period of time in the technology domain represented by the node.

The method can further comprise quantitatively analysing a network position of the innovation entity using at least one form of, for example, graph theoretic metrics, network metrics, statistics of documents in a respective technology domain and the like. In addition, the method can further comprise, prior to providing at least one suggestion, determining a degree of ease for the innovation entity to act on the at least one suggestion.

It is preferable that the degree of ease is higher for a particular technology domain if the weights of the links between the nodes representing strong technology domains of the innovation entity and the node representing the technology domain are higher. This indicates that the certain technology domain is more related to the strong technology domains.

There is also provided a non-transitory programmable storage device readable by a machine, tangibly embodying a program of instructions executable by the machine to perform a method for assessing an innovation entity within a network map of technology domains as nodes. The method is embodied by generating and visualizing the network map; assessing and visualizing a level of strength of the innovation entity in each technology domain; and providing at least one suggestion for the innovation entity for at least two nodes of the network map. It is preferable that the provision of the at least one suggestion is based on a weight of a link between the at least two nodes of the network map.

Preferably, the at least one suggestion is at least one of to enhance capabilities in respective new technology domains; and to leverage on existing technology from at least one current technology domain.

In a final aspect, there is provided a graphical user interface configured for enabling a data processor implemented method for assessing an innovation entity within a network map of technology domains as nodes, the graphical user interface comprising a plurality of fields for input of data; and a plurality of activators for triggering respective functionalities. It is preferable that the method is configured to provide at least one suggestion for the innovation entity for at least two nodes of the network map, the provision of the at least one suggestion being based on a weight of a link between the at least two nodes of the network map.

It is preferable that the plurality of fields are selected from, for example, year, country, state, city, organisation, person, initial technology domain, target technology domain to act on and the like.

Preferably, the plurality of activators are selected from, for example, locate entity, analyse entity, search nearby, find directions and the like.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIG. 1 shows an example of a cited references section of a patent document.

FIG. 2 shows a first example of an end product of the present invention.

FIG. 3 shows an example a graphical user interface used with the present invention.

FIG. 4 shows a second example of an end product of the present invention.

FIG. 5 shows a third example of an end product of the present invention.

FIG. 6 shows a fourth example of an end product of the present invention.

FIG. 7 shows a fifth example of an end product of the present invention.

FIG. 8 shows a schematic view of a server used in the some embodiments of the present invention.

### DETAILED DESCRIPTION

The present invention provides a scientifically-based data-driven decision support system, and method for innovation entities, for example, individuals, corporate entities, government agencies, states, countries, multi-country regions and so forth to, for example, evaluate their technological capability positions, explore near term innovation opportunities, explore long term innovation directions, and so forth. innovation is not a single shot, but a process of search in a heterogeneous space of various technologies. A structure of the space, together with a position of an innovation entity in the space, can determine its future prospects and paths. The technical system can generally include a network map of technology domains that is used to represent the entire technology space, and a variety of data mining and network analysis functions to locate, measure and evaluate the network positions of pertinent innovation entities on the map.

Advantageously, the present invention assists the innovation entities in deciding on what technologies to focus on for both short and long term, based on analysing, for example, the innovation entity's historical innovation records and technological competencies. Generally, the present invention is a tool for self-assessment and for steering the innovation entities towards learning or capability-building paths to attain desired long-term interests.

The present invention can be in a form of a web-based interactive decision support system that any entity can use the present invention to conduct various analyses of, for example, historical and present innovation competencies of an innovation entity, innovation evolution paths of the innovation entity, future technology domains to enter, future innovation direction and so forth. The analyses can be based on, for instance, the innovation entity's patent and publication records of innovation and technological competencies. The analytics can correspondingly provide possibilities for the innovation entity's innovation prospects, and generate guidance on capability building pathways.

It should be appreciated that even though substantial portions of the following paragraphs involve description in relation to a graphical user interface, the present invention involves more than the graphical user interface.

A first aspect involves construction and visualization of a total technology space as a network map of all known technology domains. In some embodiments, nodes which represent technology domains, are operationalized by patent classification systems, such as, for example, United States Patent Classification (DSPC), International Patent Classification (IPC), Collaborative Patent Classification (CPC), proprietary classification systems, and so forth. In some embodiments, a size of a node may correspond to a quantity of patents granted in a predefined class over a pre-determined period of time. Alternatively, it is also possible for a size of a node to correspond to a quantity of published papers from a predefined domain of technology.

There can be a weighted link between two nodes, the weighted link being an empirical representation of the knowledge and “proximity” between the two technology domains. In some embodiments, more knowledge-proximate nodes are usually located closer to each other. The “proximity” between pairs of nodes can be measured in different ways to meet different objectives, for example. Some examples of measuring “proximity” between a pair of nodes will be provided in the following paragraphs.

The first three measures (A1, A2 and A3) are based on the citations of the patents to represent the knowledge base or input to a design process. It should be appreciated that “citations” typically refer to:

(a) documents cited in the description of the patent,

(b) documents cited against the patent during the patent prosecution process of this patent and

(c) documents which have been disclosed to the patent office (e.g. documents detailed in an Information Disclosure Statement filed with the US Patent Office when the patent is a US patent).

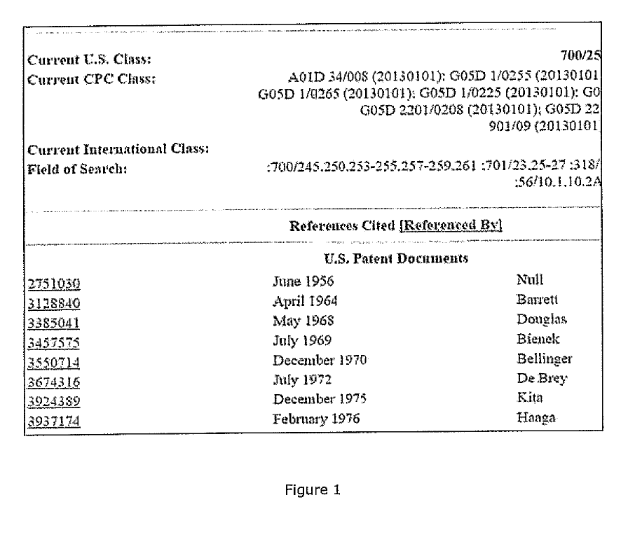

For the sake of illustration, FIG. 1 shows the “References Cited” section in a typical US patent document and the documents listed in this “References Cited” section may be used as “citations”. It may be possible to rely on at least one of (a) to (c) as “citations”.

A1. “Co-citation”: ratio of shared citations to all unique citations of patents in a pair of nodes.

A2. “Class-To-Class Cosine Similarity”: the cosine of the angle of the two vectors representing a pair of nodes' distributions of citations in, for example, patent classes 1-3,

$${Proximity}_{A , B} = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2} \times \sqrt{{\sum }_{i = 1}^{n} {( {B}_{i} )}^{2}}}} \qquad ( 1 )$$

where Aᵢ denotes the number of citations of all patents in class A whereby the citations are patents in class i. For example, if citations of patents in class A include patents I, II, III, IV and class i includes patents I and II, then Aᵢ=2. Bᵢ denotes the number of citations of all patents in class B whereby the citations are patents in class i. The cosine value is between 0 and 1, and indicates the relatedness of the knowledge bases of inventions in two technology domains.

A3. “Class-To-Patent Cosine Similarity”: the cosine of the angle of the two vectors representing two technology classes' respective distributions of citations into specific unique patents, instead of classes. A3 can be calculated using the same formulation in Equation (1) but in this instance, Aᵢ denotes the number of citations of all patents in class A whereby the citations are the specific patent i. For example, if the specific patent i is patent 11 and the citations of three patents in class A include patent II, then Aᵢ=3. Measure A3 has a better resolution compared to A2, but requires more complex computation.

The next four proximity measures (A4, A5, A6, A7) are based on design activity data, that is, the output from design process. Further, A4, A5, A6 and A7 respectively use the inventor, the firm/organization, and region as the innovation entity.

A4. “Inventor Diversification Likelihood”: minimum of pairwise conditional probabilities of an inventor (who is a person) having strong technology capability in one class, given that the inventor also has strong technology capability in the other.

R_{c,i,j}=min{Prob(RTC_{c,i}\RTC_{c,j}),Prob(RTC_{c,j}\RTC_{c,i})} (2)

RTC_{c,i} denotes inventor's, c, relative technological capability (RTC) in technology class i.

$${RTC}_{c , i} = \frac{x ( c , i )}{{\sum }_{i} x ( c , i )} / \frac{{\sum }_{c} x ( c , i )}{{\sum }_{c , i} x ( c , i )} \qquad ( 3 )$$

where x(c, i) is the number of patents of inventor c in technology class i. RTC_{c,i} detects whether innovation entity, c has more patents in class i as a share of its total patents, than the “average” innovation entity (this is true if RTC_{c,i}>1 and not true if RTC_{c,i}≦1). This measure is similar to “Relative Comparative Advantage (RCA)” in economic studies (4, 5).

A high R_{c,i,j} value indicates a higher likelihood for an inventor c to leverage solutions or knowledge across domains i and j, or to diversify his/her innovative activities across domains i and j. It may further indicate the similarity of technical knowledge or capabilities required for innovation in domains i and j.

A5. “Company Diversification Likelihood”: the formulation is the same as the “Inventor Diversification Likelihood” above (references 2 and 3), except that the innovation entity is a corporate organization.

A6. “Region Diversification Likelihood”: the formulation is the same as the “Inventor Diversification Likelihood” above (references 2 and 3), except that the innovation entity now is a region, such as a city, province, country and so forth.

A7. “Normalized co-classification”: ratio of the number of shared patents to the number of all unique patents, assigned in a pair of patent classes. A7 relies on the information of the co-classifications of patents, to quantify joint occurrences of a pair of patent classes for patents. Co-classification means that a patent is assigned to more than one patent class.

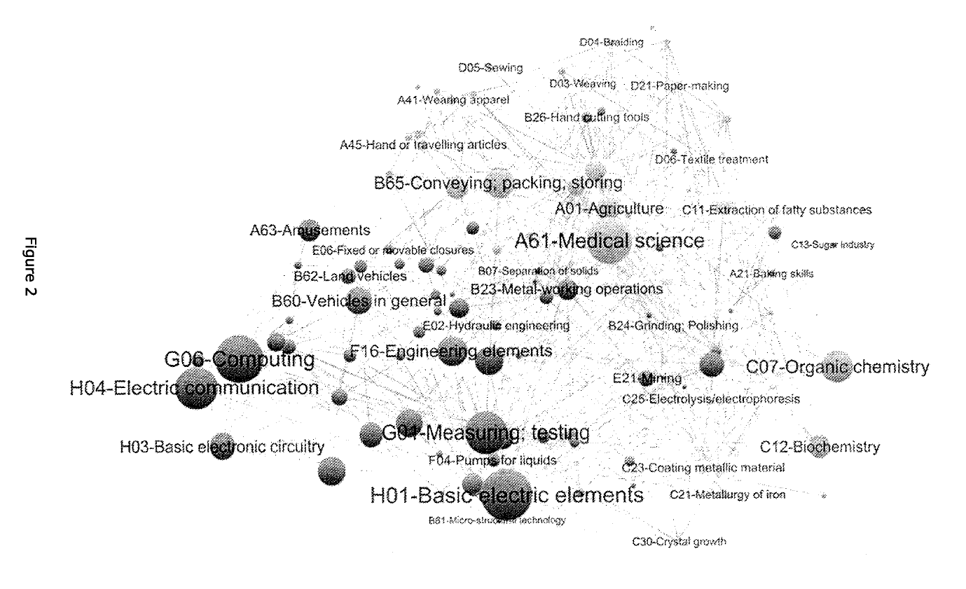

The network map can be created using a combination of proximity measures (some examples provided in A1 to A7) and a patent classification system, as well as a predetermined period from a patent database in a chosen period of time (e.g. 2005-2010, or just 2010). For example, FIG. 2 denotes an example of the network map using relatedness metric A3 for the links and IPC classes for the nodes, based on all US patent records from 1976 to 2011.

In FIG. 2, the weakest edges are removed such that removal of one additional stronger edge would disjoint the total network in the network map. The network can be filtered using alternative network filtering methods (6). A few relatively cohesive clusters of technology classes were identified by using the Louvain method (7) and shaded differently in FIG. 2. The use of richer historical records (more years of patent data) for the calculation of link weights provide more systematic empirical approximation of the association of technology domains in the network map. Such a network map can alternatively be built using USPC, CPC or proprietary classification systems, and databases of international patents such as China patents, for the analytics functions.

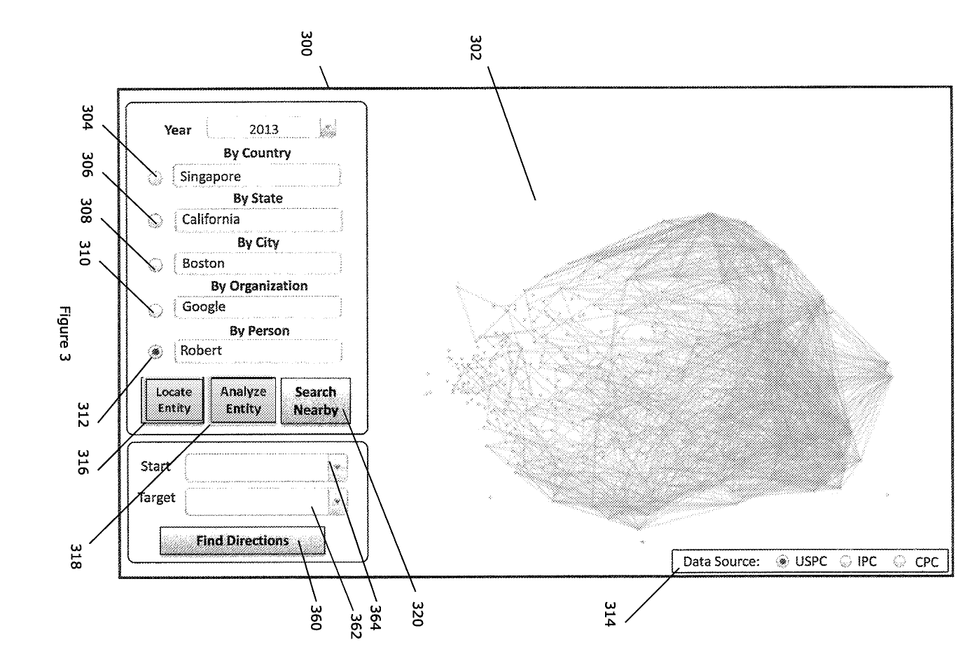

In the course of generating the network map, it may be possible to periodically retrieve data from patent record databases, to continually update the network map, and support a plurality of functions for analysis, visualization and reporting. FIG. 3 illustrates a sample graphical user interface (GUI) 300 that enables the various functionalities. Using the GUI 300, the network map 302 can be generated by selecting at least one parameter of, for example, country 304, state 306, city 308, organisation 310, person 312, and classification system 314.

The aforementioned analytics functions will now be described in detail.

A first function of the GUI 300 allows users to search or choose a specific innovation entity (which can be a person, organization, city, state, or country) for mining their specific records of patents and proven technology capabilities in a specific time period in the USPTO database (as shown in FIG. 3).

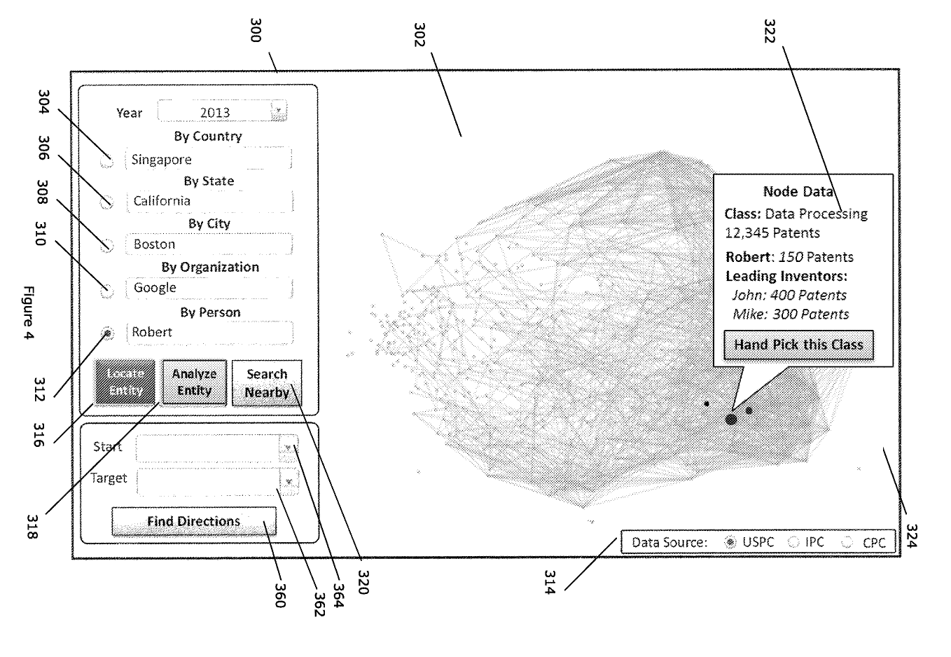

On that basis, the user can also highlight the technology classes where the chosen innovation entity has a strong innovation capability in a chosen period of time. For example, as illustrated in FIG. 4, when the user clicks a “Locate Entity” button 316, the nodes where the chosen entity (e.g. “Robert”) has substantial technology competencies and indicate them using a different colour (black in FIG. 4).

Alternative methods can be used to assess and visualize an innovation entity's technology capability strength in a domain represented as a node in the network of technology classes. For example, the following methods can be used.

B1. A patent quantity of the innovation entity in a technology class in a predetermined period of time can be determined, and denoted using a colour of the corresponding node.

B2. A proportion of the innovation entity's patents to total patents in a specific technology class in a predetermined period of time can be determined and denoted using a colour of the corresponding node.

B3. RTC_{c,i} (as provided in reference 3) for a specific innovation entity in a specific technology class in a predetermined period of time can be determined, and denoted using a colour of the corresponding node.

B4. Defining an innovation entity as having “strong” technology capability in a technology class i where its RTC_{c,i} value is greater than 1, indicating this entity is better than an “average” innovation entity in that technology class. Then all requisite nodes where the specific innovation entity's RTC_{c,i} value is greater than 1, in a predetermined period of time are denoted.

B5. Defining an innovation entity as having “strong” technology capability in a technology class where it has a higher than average number of patents amongst all innovation entities in that technology class. Then all the nodes where the specific innovation entity has more patents than an average innovation entity in a predetermined period of time are denoted.

In some embodiments, non-patent information can be used to assess the knowledge or capability position of an innovation entity who has no or few patents. Although the network map is constructed based on patent records and shows the empirical association of technology fields based on patent data, it can still be used to assess a knowledge position of an innovation entity who has no or few patents. For example, if an innovation entity has no or few patents, the user can browse through the network map to search for the domains that the innovation entity has established strong technology capabilities, based on non-patent records, or even qualitative knowledge about the entity, and seek their nodes to highlight manually.

To support the search for nodes representing alternative technology classes, the GUI 300 can have an interactive function that displays the title and descriptive information of a technology class.

Referring to FIG. 4, when the user clicks a specific node (representing a technology class), its total number of patents, the number of the patents of the chosen innovation entity in the class, and the leading innovation entities (same type as chosen one for analysis), can be indicated in a node information panel 322. The user can trigger a selector 324 in the node information panel 322 for highlighting the node. An individual knowing their own competencies can browse through the nodes on the map 302 by clicking on the nodes for the information in the node information boxes to determine which node is appropriate. For example, a representative of a company designing data storage technologies (whereby the company does not have any patent but is involved with data storage technologies) can use the map 302 to determine the nodes at which the company is located. In particular, the representative can search through the nodes in the map 302 by clicking on each node to find out what domain each node represents and the information related to each domain through the corresponding node information panel 322. Similarly, an automotive repair technician may have extensive knowledge about automobiles, but might not have a patent. He can however still browse through the map to find his position on the map 302, for example, nodes related to vehicle engineering, combustion engine, and the like. This positioning indicates a knowledge/competency position, which additional technology domains he can enter next or learn solutions from while remaining in the automobile domain, and identify experts from domains he can collaborative easily and meaningfully.

A second function of the GUI 300 is to quantitatively analyse various aspects of the network positions of a chosen innovation entity, using graph theoretic metrics, such as, for example, centrality metrics, clustering coefficients, etc (8, 9), proprietary measures and present these measurements either graphically or numerically on the screen. For example, the following are some measures to carry out such analysis.

C1. The sum of the values of all the weighted links of all the domains where an innovation entity c has developed strong capabilities with its unoccupied domains where its technology capability is not strong.

$${ω}^{c} = {\sum }_{i} {\sum }_{j ( \neq i )} {x}_{i} {ϕ}_{ij}$$

where φ_{i,j} is the link weight between domain i and j and may be calculated using one of the measures A1 to A6 described above. It is up to the user to decide which one of these measures A1 to A6 to use when he/she sets up the system. xᵢ=1 if innovation entity c is strong in technology class i; xᵢ=0 if innovation entity c is not strong in technology class i.

Whether innovation entity c is strong in a node can be determined based on B4 (i.e. the innovation entity is strong in a node representing technology class i if RTC_{c,i}>1) or B5 (i.e. the innovation entity is strong in a node representing a technology class if the innovation entity has more patents than an average inventor in this technology class). The measure ω^{c} may indicate the potential of innovation entity c to enter any new domains, or to leverage knowledge from new domains for innovation in its current strong domains, in a predetermined time period. A higher ω^{c} indicates a higher potential of the innovative entity c to enter any new domains, or to leverage knowledge from new domains for innovation in its current strong domains, in a predetermined time period.

C2. The average proximity value of the links between all pairs of domains (network nodes) where the innovation entity has built strong capabilities (based on either B4 or B5),

$${ϛ}^{c} = {\sum }_{i} {\sum }_{j} {x}_{i} {x}_{j} {ϕ}_{i , j} / {\sum }_{i} {\sum }_{j} {x}_{i} {x}_{j}$$

The measure ζ^{c} may indicate the coherence of the domains where the innovation entity c has built strong technology capabilities, or the specialization of capability of the innovation entity, in a predetermined time period.

C3. The total number of domains (nodes) where the specific innovation entity has built strong technology capabilities in a predetermined time period. An assessment of “being strong” can be based on measure B4 or B5.

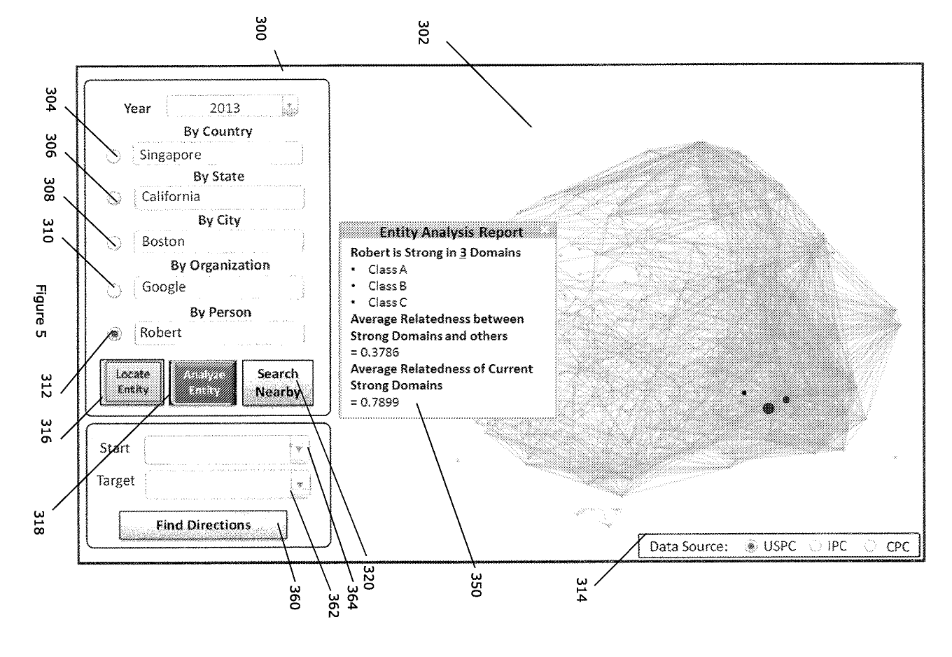

In some embodiments, network metrics and statistics from the prior art are used to measure, assess and present the network positions and characteristics of a specific innovation entity. Such an analysis is presented in the “Analysis Report” 350 in FIG. 5. The report 350 is generated when the user triggers the “Analyse Entity” button 318. It should be appreciated that the present invention allows add-on functionalities from external users or software developers.

A third function of the GUI 300 relates to highlighting and/or presenting the most proximate domains in the network map 302 of the current strong domains of the innovation entity. These closest neighbour domains are typically the most feasible and easiest in relation to innovating, learning and inspiring, and building up of capabilities in a short duration, because innovation in those domains typically require competencies and capabilities similar or related to what the innovation entity has in place. However, a possibility of breakthroughs resulting from expanding into such neighbouring domains is moderate.

In some embodiments, it can be possible, via the GUI 300, to suggest new and distant domains that the innovation entity can enter to expand its knowledge so as to increase a possibility of breakthroughs from their research activities. Typically, the network map 302 provides information about the distances between technology domains to support the decision making of the innovation entity. However, it is still up to the innovation entity to decide which technology domain to explore. Some innovation entities may prefer less difficulty so they enter near domains (more proximate domains), some may prefer challenges and a higher possibility of breakthroughs by entering distant domains (the less proximate domains), while others prefer a middle ground.

The suggestions for domains can be based on different rationales, depending on a preference of a user. The rationale can be input by the user prior obtaining the suggestions.

A proximity of each domain to another domain is indicated by a weight of the link between two domains. For example, a strongest technology domain of the innovation entity is first identified (using, for example, any of measures B1 to B5). Then a group of technology domains having links to this strongest technology domain is identified. From this group, a first percentage (X %) of technology domains having links with the highest weights to the strongest technology domain are identified as “most proximate” technology domains, a second percentage (Y %) of technology domains having links with the lowest weights to the strongest technology domain are identified as “least proximate or most distant” technology domains and the remaining technology domains in the group are identified as “modestly proximate” technology domains. The values of “X” and “Y” can be determined by the user.

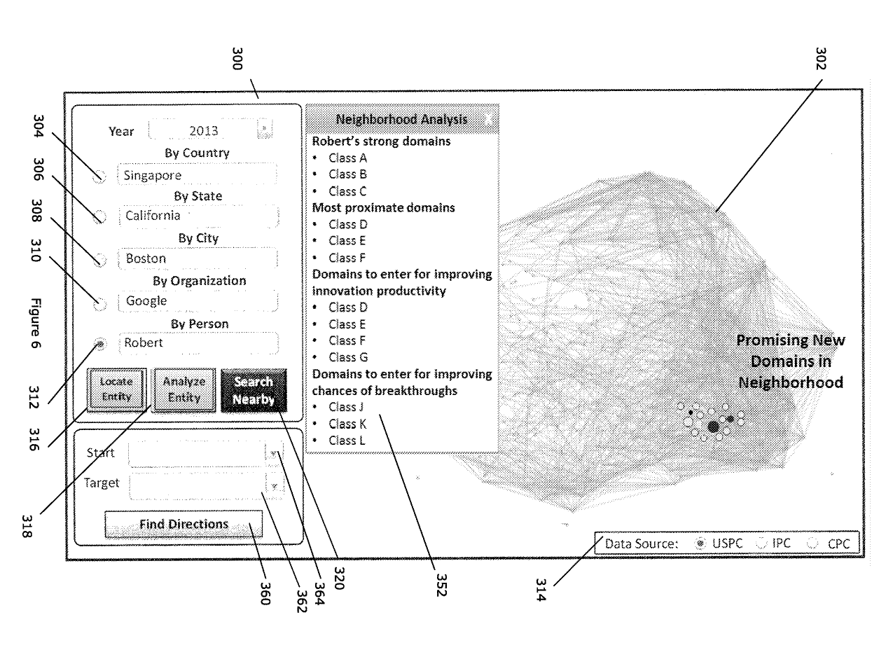

Referring to FIG. 6, when the user clicks a “Search Nearby” button 320, the more proximate new domains in the neighbourhood of the strong domains (in black) of the innovation entity will be highlighted (shown as empty circles) in the network map 302. A message box (“Neighbourhood Analysis” 352) with information on the neighbourhood domains (most proximate domains), and suggestions of domains for consideration by the innovation entity. It should be noted that a number of listings within each category of the “Neighbourhood Analysis” 352 is flexible and may be set by the user.

A fourth function of the GUI 300 allows users to choose target domains of long term interest, and then use network algorithms to identify the shortest incremental capability building paths from the current domains (the innovation entity's strong domains) to the target ones, and also visualize, highlight and present details of the paths. The target domains may be suggested technology domains as described in the preceding paragraphs. For example, building technology capabilities in technology domains least proximate to the strong technology domains of an innovation entity typically requires undergoing a path of building capabilities from a technology area with a higher degree of ease of entry (one of the most proximate technology domains) to a target domain with a lower degree of ease of entry (one of the least proximate or most distant technology domains). The fourth function of the system helps identify this path.

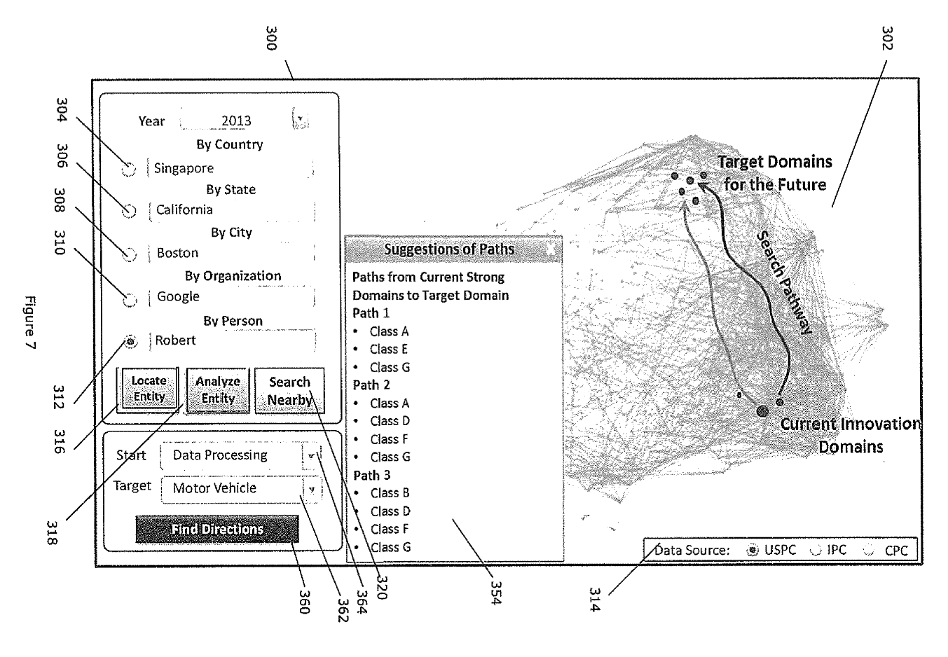

The shortest path problem is a longstanding issue in graph theory and network analysis, for which a number of optimal and heuristic algorithms exist and can be implemented (10). The domains along the shortest paths are where it may be desirable for the innovation entity to invest to build up intermediate capabilities before it can effectively understand and learn about the past inventions or eventually invent in the target domains. FIG. 7 illustrates such a feature. When the user inputs start 364 and target 362 fields and triggers a “Find Directions” button 360, suggested paths of network nodes will be highlighted in the network, and also reported in a “Suggestion of Paths” 354.

A fifth function of the GUI 300 is to generate intelligent expert advice on alternative approaches and plans to engage domains and develop paths, and provide them to users in an easily understood manner. The expert advice can include, for example, suggesting entry into certain domains, learning certain technologies for improving innovation productivity, mastering a subspace of strong domains to provide the innovation entity better chances of breakthroughs and so forth. The “Neighbourhood Analysis” 352 and “Suggestion of Paths” 354 in FIGS. 6 and 7 respectively provide such information for the user.

It should be appreciated that the system underpinning the GUI 300 is not limited to the above mentioned interactive visualization and analytics functions. It is a generic data-driven innovation support system, primarily based on (but not limited to) using patent data, powered by mathematical network algorithms. It is configured to be intuitive and easy to use by innovation entities who make decisions on innovation and related capability building activities for short or long term durations. Although the preceding paragraphs refer to use of granted patents when forming the network map 302, other types of technical documents such as, for example, journal papers, scientific publications, conference proceedings, and so forth can also be used in a similar manner as patents. For example, if journal papers are used, the network map represents scientific knowledge space and is useful for guiding similar decisions in the academic research process aimed at creating new knowledge. Alternative measures to what is described in the preceding paragraphs may also be used to generate the network map 302.

The present invention provides a scientifically-grounded data-driven decision support system for innovation entities to more systematically and accurately evaluate their capabilities at key junctures, explore short-term invention opportunities and provide directions and paths for long-term technology capability-building. It should be appreciated that this is a data-driven technical tool to assist in innovation decision making. The invention can be used in many applications other than innovation decision making. The system may be implemented as a standalone software developed in Java or HTML. It can also be accessible via a website, a computer software or an application software on mobile devices.

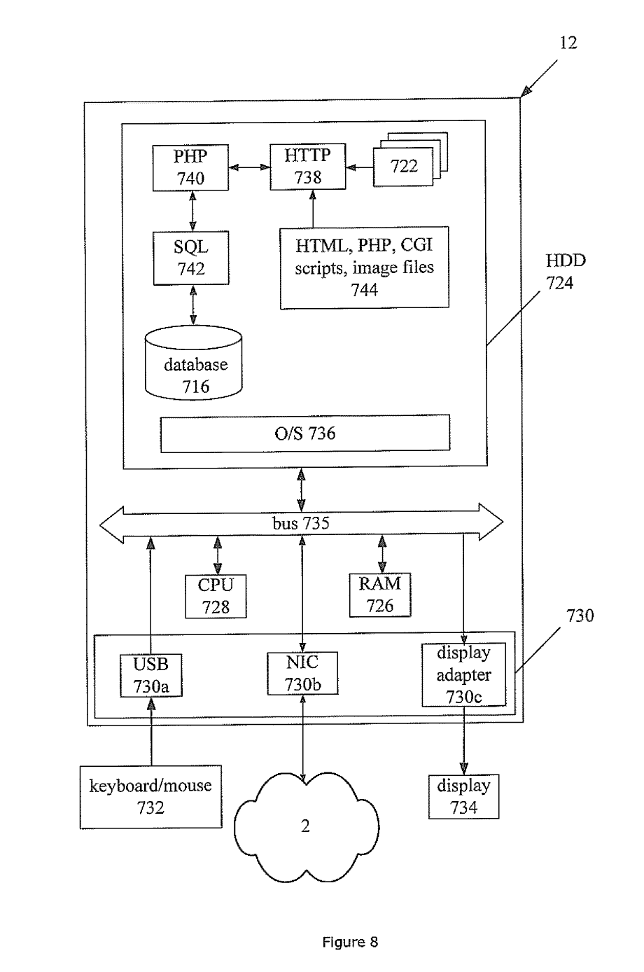

Referring to FIG. 8, the server 12 is a commercially available server computer system based on a 32 bit or a 64 bit Intel architecture, and the processes and/or methods executed or performed by the computer server 12 are implemented in the form of programming instructions of one or more software components or modules 722 stored on non-volatile (e.g., hard disk) computer-readable storage 724 associated with the server 12. At least parts of the software modules 722 could alternatively be implemented as one or more dedicated hardware components, such as application-specific integrated circuits (ASICs) and/or field programmable gate arrays (FPGAs). The server 12 can be used to run the GUI 300 in some embodiments, and can be used to carry out requisite aspects of the present invention.

The server 12 includes at least one or more of the following standard, commercially available, computer components, all interconnected by a bus 735:

1. random access memory (RAM) 726;

2. at least one computer processor 728, and

3. external computer interfaces 730:

a. universal serial bus (USB) interfaces 730a (at least one of which is connected to one or more user-interface devices, such as a keyboard, a pointing device (e.g., a mouse 732 or touchpad),

b. a network interface connector (N IC) 730b which connects the server 12 to a data communications network, such as the Internet 2; and

c. a display adapter 730c, which is connected to a display device 734 such as a liquid-crystal display (LCD) panel device.

The server 12 includes a plurality of standard software modules, including:

1. an operating system (OS) 736 (e.g., Linux or Microsoft Windows);

2. web server software 738 (e.g., Apache, available at http://www.apache.org);

3. scripting language modules 740 (e.g., personal home page or PHP, available at hftp://www.php.net, or Microsoft ASP); and

4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 12 with the general ability to allow users of the Internet 2 with mobile device 100 equipped with standard web browser software to access the server 12 and in particular to provide data to and receive data from the database 716. It will be understood by those skilled in the art that the specific functionality provided by the server 12 to such users is provided by scripts accessible by the web server 738, including the one or more software modules 722 implementing the processes performed by the server 12, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field- programmable gate array (FPGA), the design of a gate array or full-custom application-specific integrated circuit (ASIC), or the like.

Each of the blocks of the flow diagrams of the processes of the server 12 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Whilst there have been described in the foregoing description preferred embodiments of the present invention, it will be understood by those skilled in the technology concerned that many variations or modifications in details of design or construction may be made without departing from the present invention.

### REFERENCES

[1] Jaffe, A. B., and Trajtenberg, M. (2002). Patents, Citations, and Innovations: A Window on the Knowledge Economy. Cambridge, Mass.: MIT Press.
[2] Ahlgren, P., Jarneving, B., and Rousseau, R. (2003). Requirements for a co-citation similarity measure, with special reference to Pearson's correlation coefficient. Journal of the American Society for Information Science and Technology, 54(6), 550-560.
[3] Leydesdorff, L. Kushnir, D., Rafols, I. (2014) Interactive overlay maps for US patent (USPTO) data based on International Patent Classification (IPC).

Scientometrics, 98(3), 1583-1599.
[4] Balassa, B. (1986) Comparative advantage in manufactured goods: A reappraisal. The Review of Economics and Statistics, 68(2), 315-19.
[5] Hidalgo, C. A., Klinger, B. and Hausmann, R. (2007) The product space conditions the development of nations. Science, 317, 482-487.
[6] Yan, B., Luo, J. (2016) Filtered Patent Maps for Predicting Technology Diversification Paths of Inventors and Organizations. DRUID Asia Conference, February 23-25, Singapore.
[7] Blondel, V. D., Guillaume, J.-L., Lambiotte, R., Lefebvre, E. (2008) Fast unfolding of communities in large networks. Journal of Statistical Mechanics: Theory and Experiment, P10008.
[8] Newman, M. E. J. (2003) The structure and function of complex networks. SIAM Review, 45, 167-256.
[9] Newman, M. E. J., Barabasi, A.-L. and Watts, D. J. (2006) The Structure and Dynamics of Networks. Princeton University Press.
[10] Cherkassky, B. V., Goldberg, A. V., and Radzik, T. (1996) Shortest path algorithms: Theory and experimental evaluation. Mathematical Programming, 73(2):129-174.

1. A data processor implemented method for assessing an innovation entity within a network map, the method comprising:
generating the network map;
assessing a level of strength of the innovation entity in each technology domain; and
providing at least one suggestion for the innovation entity for at least two nodes of the network map,
wherein the provision of the at least one suggestion is based on a weight of a link between the at least two nodes of the network map.

2. The method of claim 1, wherein the at least one suggestion is at least one of:
to enhance capabilities in respective new technology domains; and
to leverage on existing technology from at least one current technology domain.

3. The method of claim 1, whreein the network map comprises a plurality of nodes and a plurality of links.

4. The method of claim 1, wherein the innovation entity is selected from a group consisting of: an individual, a corporate entity, a government agency, a state, a country and a multi-country region.

5. The method of claim 1, wherein the weight of a link is based on citations of technical documents established over a predetermined period of time in technology domains represented by respective nodes.

6. The method of claim 5, wherein the weight of a link is determined using at least one measure selected from a group consisting of:
ratio of a number of the citations in common in the technology domains represented by the pair of nodes to a number of the citations not in common in the technology domains represented by the pair of nodes,
cosine of an angle of two vectors representing how the citations in the technology domains represented by the pair of nodes are distributed across different technology domains, and
cosine of an angle of two vectors representing how the citations in the technology domains represented by the pair of nodes are distributed across different technical documents.

7. The method of claim 1, wherein the weight of a link is based on minimum pairwise conditional probabilities of the innovation entity having strong technology capability in a first technology domain, given that the innovation entity also has strong technology capability in a second technology domain.

8. The method of claim 1, wherein the weight of a link is based on a ratio of shared technical documents to a number of unique technical documents in the technology domains represented by the pair of nodes.

9. The method of claim 1, wherein the network map further comprises information for each node relating to the technology domain represented by the node.

10. The method of claim 1, wherein each node has a size indicative of a number of documents established over a predetermined period of time in the technology domain represented by the node.

11. The method of claim 1, further comprising quantitatively analysing a network position of the innovation entity using at least one form of: graph theoretic metrics, network metrics and statistics of documents in a respective technology domain.

12. The method of claim 2, further comprising, prior to providing at least one suggestion, determining a degree of difficulty for the innovation entity to act on the at least one suggestion.

13. The method of claim 12, wherein the degree of difficulty is higher for a particular technology domain if the weights of the links between the nodes representing strong technology domains of the innovation entity and the node representing the certain technology domain indicates that the certain technology domain is more related to the strong technology domains.

14. A non-transitory programmable storage device readable by a machine, tangibly embodying a program of instructions executable by the machine to perform a method for assessing an innovation entity within a network map, the method being embodied by:
generating the network map;
assessing a level of strength of the innovation entity in each technology domain; and
providing at least one suggestion for the innovation entity for at least two nodes of the network map,
wherein the provision of the at least one suggestion is based on a weight of a link between the at least two nodes of the network map.

15. The storage device of claim 14, wherein the at least one suggestion is at least one of:
to enhance capabilities in respective new technology domains; and
to leverage on existing technology from at least one current technology domain.

16. A graphical user interface configured for enabling a data processor implemented method for assessing an innovation entity within a network map, the graphical user interface comprising:
a plurality of fields for input of data; and
a plurality of activators for triggering respective functionalities,
wherein the method is configured to provide at least one suggestion for the innovation entity for at least two nodes of the network map, the provision of the at least one suggestion being based on a weight of a link between the at least two nodes of the network map.

17. The graphical user interface of claim 16, wherein the plurality of fields are selected from a group consisting of: year, country, state, city, organisation, person, initial technology domain, and final technology domain.

18. The graphical user interface of claim 16, wherein the plurality of activators are selected from a group consisting of: locate entity, analyse entity, search nearby and find directions.
